(19) United States
(12) Patent Application Publication
(10) Pub. No.: US 2007/0019961 A1
(43) Pub. Date: Jan. 25, 2007

(54) NETWORK SECURITIZATION

(75) Inventor: John J. Pembroke, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: John J. Pembroke, Evergreen, CO (US)

(21) Appl. No.: 11/458,593

(22) Filed: Jul. 19, 2006

Related U.S. Application Data
(60) Provisional application No. 60/701,735, filed on Jul. 22, 2005.

(51) Int. Cl. H04B 10/00

(52) U.S. Cl. 398/128; 705/38

(57) ABSTRACT

Methods and systems are provided of securitizing a network, such as a fiber network and/or a high-speed wireless network to a group of homes. An identification of real property for one of the homes is received. A total loan value is calculated for the real property that includes a network access charge representing a unit cost for establishing a network connection from the real property to a network operations center to access telecommunications services and includes an activation cost for activating the network connection. A loan secured by the real property for the total loan value is initiated.

### CROSS REFERENCE TO RELATED APPLICATION

This application is a nonprovisional of, and claims the benefit of the filing date of, U.S. Prov. Pat. Appl. No. 60/701,734, entitled “NETWORK SECURITIZATION,” filed Jul. 22, 2005 by John J. Pembroke, the entire disclosure of which is incorporated herein by reference for all purposes.

### BACKGROUND OF THE INVENTION

This application relates generally to fiber-optic and high-speed wireless networks. More specifically, this application relates to securitization of fiber-optic networks.

It is well known that in recent years that has been a persistent increase in the global demand for bandwidth. While traditional telecommunications have relied on the use of copper-wire connections, such mechanisms are now viewed as inadequate to support the bandwidth requirements being demanded by consumers to support such diverse network functionality as audio, video, and data. Instead, current telecommunications systems are emphasizing the use of fiber-optic and wireless networks in which optical rather than electrical signals are used to transmit information. Such networks have significantly greater bandwidth capabilities.

The ability of customers to receive optical communications signals is thus dependent on the existence of fiber-optic communications links to their locations. Real-estate development has thus increasingly included the deployment of fiber-optic connections, both in residential and commercial developments. But to include such fiber-optic communications is costly and there is accordingly a general need in the art for cost-efficient methods of making fiber-optic networks available.

### BRIEF SUMMARY OF THE INVENTION

Embodiments of the invention thus provide methods and system of securitizing a network to a group of homes. In a first set of embodiments, an identification of real property for one of the homes is received. A total loan value is calculated for the real property that includes a network access charge representing a unit cost for establishing a network connection from the real property to a network operations center to access telecommunications services and includes an activation cost for activating the network connection. A loan secured by the real property for the total loan value is initiated.

In some such embodiments, issuance of an investment coupon is initiated to an investor to generate funds to finance costs for establishing the network. The investment coupon may include an undivided interest in the network and may be issued according to a first-in-first-out formula. The investment coupon may be issued for a cost approximately equal to the unit cost. Redemption of the investment coupon may also be initiated, such as in response to closing the loan.

In some instances, the unit cost comprises a cost for establishing a network connection from the real property to a local distribution center and a cost for establishing a network connection from the local distribution center to the network operations center. The telecommunications services may comprise voice, video, data, and home-security services.

Different types of networks may be securitized in different embodiments of the invention. For example, in some embodiments, the network comprises a fiber network and the network connection comprises a fiber network connection, while in other embodiments, the network comprises a high-speed wireless network and the network connection comprises a high-speed wireless connection.

In a second set of embodiments, issuance of a plurality of investment coupons is initiated to investors to generate funds to finance costs for establishing the network. Each of the investment coupons includes an undivided interest in the network.

The investment coupons may be issued according to a first-in-first-out formula. Redemption of at least one of the investment coupons may also be initiated, such as in response to closing a loan for purchase of one of the homes.

These embodiments may also accommodate different types of networks, with the network comprising a fiber network in some embodiments and comprising a high-speed wireless connection in other embodiments.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram of a structure that may be used for deployment of telecommunications over a fiber-optic network in some embodiments;

FIG. 2 is a schematic illustration of a functional environment in which a bundling company may operate it accordance with embodiments of the invention;

FIG. 3 is a schematic block diagram illustrating the structure of a computer system on which methods of the invention may be embodied;

FIG. 4 is a flow diagram illustrating a method for financial certain products and/or services with a loan secured by real property; and

FIG. 5 is a flow diagram illustrating a method for financing fiber-optic costs in an embodiment.

### DETAILED DESCRIPTION OF THE INVENTION

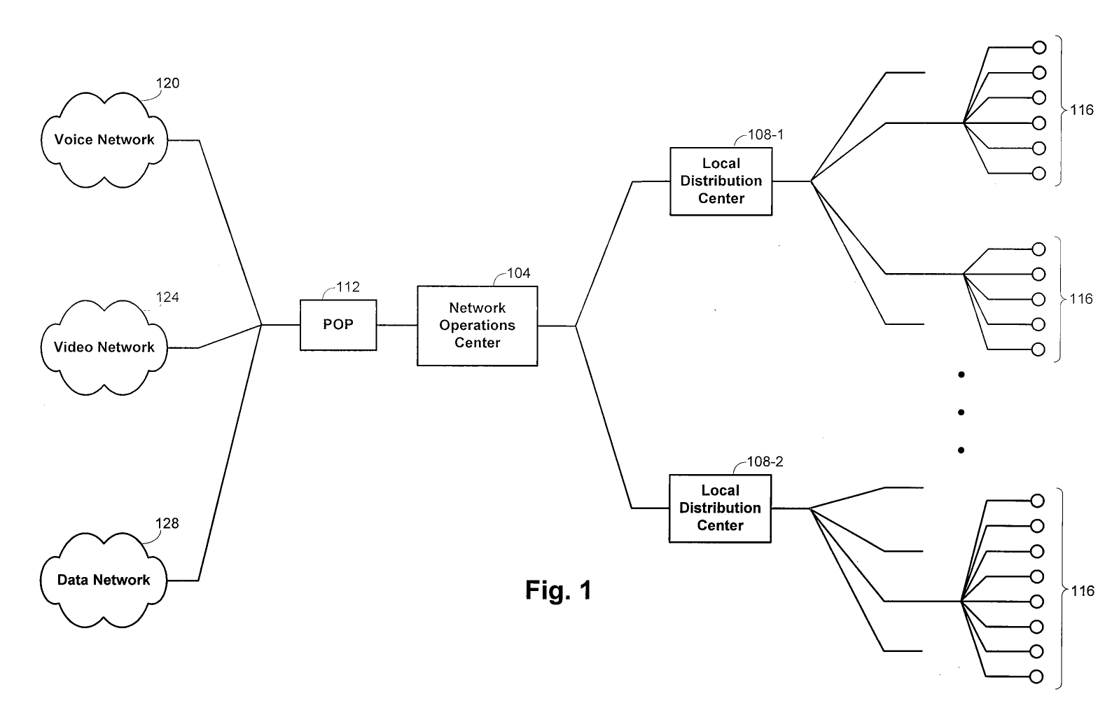

Embodiments of the invention provide for the securitization of fiber-optic and high-speed wireless networks. A general overview of a structure that may be used in providing services over such fiber-optic and high-speed wireless networks is illustrated schematically in FIG. 1. Access to the various networks, which are shown in the drawing as a voice network 120, a video network 124, and a data network 128, is made over fiber-optic and wireless communication lines, which are shown in the drawing as solid lines. Merely by way of example, the voice network 120 may provide high-speed telephone communications service, the video network 124 may provide television content, and the data network 128 may provide Internet service. The illustration of three networks is not intended to be limiting and other networks may be provided in different embodiments, providing combinations or portions of the illustrative services or perhaps providing additional services.

Access to the networks 120, 124, and 128 is made possible through fiber-optic cable and high-speed wireless equipment that is deployed throughout a geographical region. For example, in the United States, major fiber-optic backbone structures connect the vast majority of U.S. cities to such networks. These fiber distributions include point-of-presence nodes 112, which are junction locations that permit connections to be made to allow smaller towns and subdivisions access to the networks 120, 124, and 128. Within such towns and at entrances to such subdivisions, the fiber lines are split into smaller bundles, perhaps with divisions being performed at multiple nodes, with individual fiber lines eventually being provided to endpoint locations 116. The endpoint locations may comprise individual houses, apartments, businesses, or other locations. In addition, a wireless network can overlay the community like a “cloud” affording the citizens connectivity to the fiber-optic backbone.

Traffic over the fiber-optic lines and the high-speed wireless network from the various networks 120, 124, and 128 is directed by a network operations center 104, which may be a manned location that houses equipment used in delivering voice, video, data, home security, and perhaps other services from the networks. For example, the network operations center 104 may receive television content from one or more wholesale providers of such content from over fiber lines or alternatively from satellite transmissions. In one embodiment, the television signal is distributed to customers over the fiber lines using internet protocol television (“IPTV”), a recently developed protocol that enables such transmissions. Dial-tone telephone functionality may also be transmitted over the fiber lines from the network operations center 104 to the endpoint locations 116 in one embodiment using a “soft switch,” which connects Voice over Internet Protocol (“VoIP”) to the public telephone system. Personnel located at the network operations center 104 may monitor the integrity of the fiber distribution and the quality of service being delivered to the customers.

The network operations center 104 may also monitor and control a plurality of local distribution centers 108. It is generally anticipated that each of the local distribution centers 108 will be unmanned, but this is not a requirement and in some instances one or more of the local distribution centers 108 may have some personnel. The local distribution centers 108 act to extend the effective coverage of the network operations center 104. The range of the network operations center 104 to deliver the network services is generally a function of the cost of transporting the content provided by those networks 120, 124, and 128 over the fiber and wireless structure. The costs associated with laying the fiber may vary according to a number of factors, including the capacity of the individual fiber lines, the soil conditions for trenching, and the like. In providing an illustration below, the costs for providing fiber may be considered in three categories. First is the cost of providing a fiber and high-speed wireless connection from the fiber backbone to the network operations center 104; this cost may vary depending on the cost charged by the owner of the fiber line. Second is the cost of distributing the fiber from the network operations center 104 and/or the local distribution center 108 to the subdivision; this is referred to in the art as the fiber's “common area.” Third is the cost of bringing the fiber line from the street to the house; this is referred to in the art as the fiber “drop.”

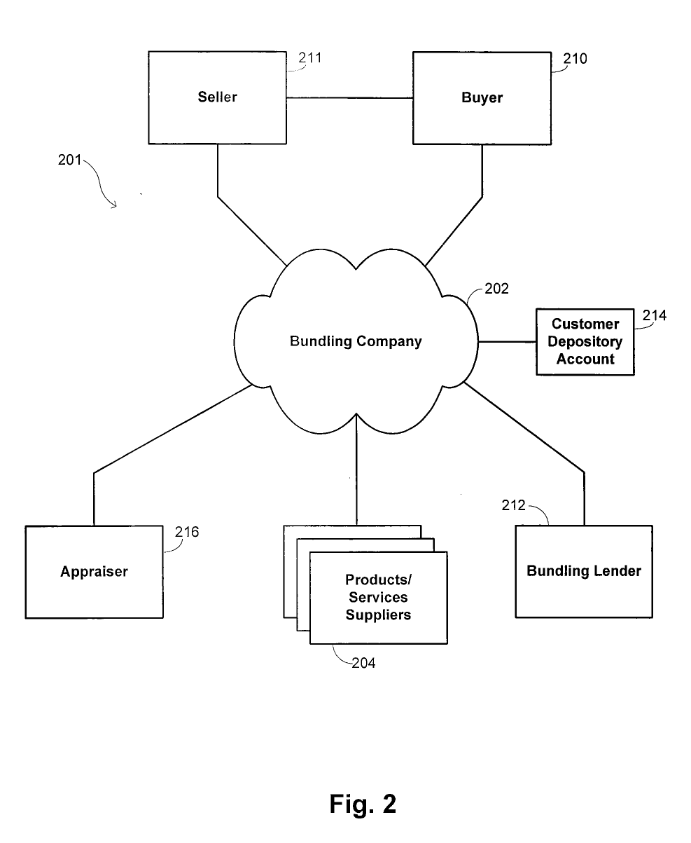

In embodiments of the invention, access to the fiber and the high-speed wireless networks by a homeowner may be included as part of a more comprehensive set of products and/or services that are bundled with a loan secured by real property, such as a mortgage or home equity line of credit. FIG. 2 provides a general overview of an environment in which such bundling may be provided. The secured loan is provided by a “bundling lender” 212, which is any entity that provides a real-estate-secured loan that bundles at least some products and services. Examples of entities that may be comprised by the bundling lender include mortgage brokers, mortgage bankers, commercial banks, finance companies, credit unions, insurance companies, stock brokerage firms, and individual investors; it is not necessary according to embodiments of the invention that the bundling lender 212 be associated with a financial institution. The bundling of products and/or services is coordinated by a “bundling company” 202, which interacts with the bundling lender 212. The bundling company 202 may comprise any entity that offers bundleable products and/or services to be included in a loan and/or that facilitates the marketing or sale of bundleable products and/or services. Examples of bundling companies in certain specific embodiments include suppliers of products and services, mortgage bankers, mortgage brokers, real estate agents, real estate brokers, builders, land developers, financial planners, or various facilitators such as independent marketing entities, title companies, insurance companies, appraisers, etc.

The bundling company 202 has relationships with one or more suppliers 204 of products and services, and may negotiate discounted prices for the products and services, using its position as an interface to large volumes of such products and services for many potential customers to obtain very favorable prices. The bundling company 102 may then offer the products and services to a homeowner who wishes to bundle them with the loan securing the associated real property. In the illustration, the homeowner is a buyer 210 or seller 211 of the real property such as may occur when the property is sold, but more generally the ability to bundle may be extended to any homeowner. The offered prices for the products and/or services may be at retail, less than retail, and may include a transaction charge. In addition to interacting with these entities, the bundling company 202 may interact with a number of other entities, examples of which include the suppliers of products and services 204, appraisers 216, and one or more bundling lenders 212, who actually provide the loan. The bundling company 202 may maintain a customer depository account 214, the use of which is described further below, although in some embodiments the customer depository account may be maintained by a separate institution. While the foregoing description provides an overview of the structure used by a bundling company, further details are set forth in U.S. patent application Ser. No. 11/039,367, entitled “METHODS AND SYSTEMS FOR FINANCING EXPENSES WITH A LOAN SECURED BY REAL PROPERTY,” filed Jan. 18, 2005 by John J. Pembroke (“the '367 application”), the entire disclosure of which is incorporated herein by reference for all purposes. In some embodiments, the bundling company 202 manages operation of the network operations center 104.

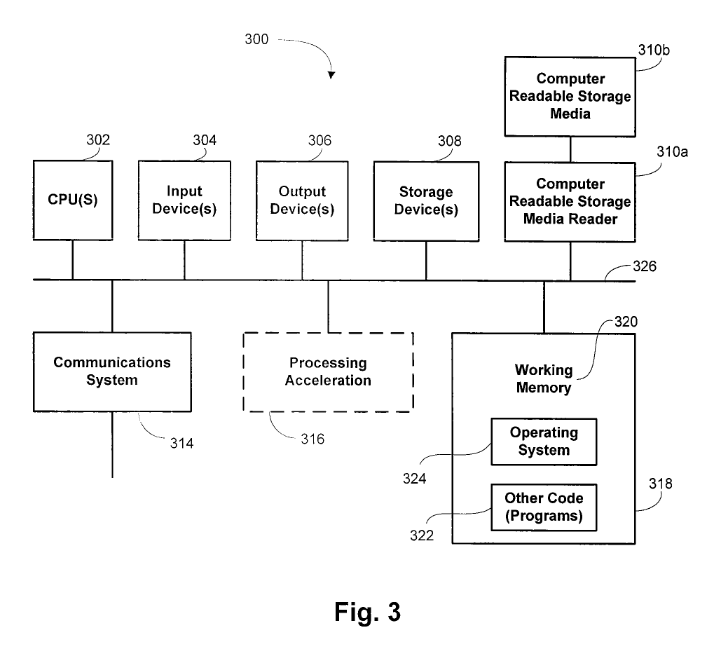

The bundling company 212 may use a computational system like one having the structure shown in FIG. 3 to coordinate methods for bundling products and securitizing the fiber-optic and high-speed wireless networks as described further below. The computational system 300 is shown comprised of hardware elements that are electrically coupled via bus 326, including a host processor 302, an input device 304, an output device 306, a storage device 308, a computer-readable storage media reader 310a, a communications system 314, a processing acceleration unit 316 such as a DSP or special-purpose processor, and a memory 318. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the other computational devices to implement embodiments as described.

The computational device 300 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

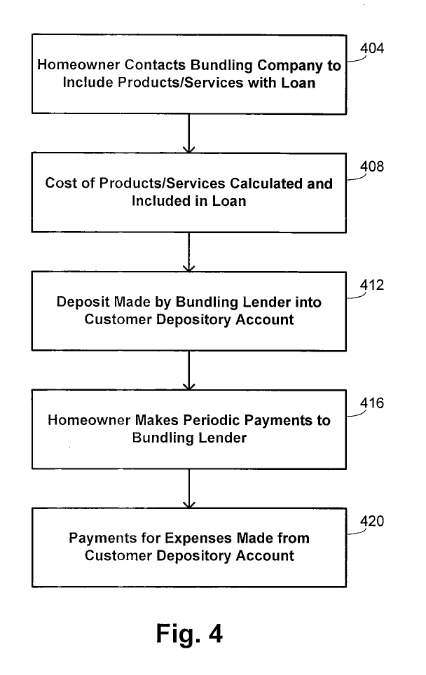

The flow diagram of FIG. 4 broadly illustrates steps that may be performed in establishing and using the customer depository account 214 to pay for expenses. This diagram is generalized to describe a number of different types of loan arrangements, each of which is secured by real property, with more specific descriptions being provided in the '367 application. At block 404, the homeowner contacts the bundling company 212 to initiate including the products and/or services as part of the loan structure for any loan secured by real property. The cost of these products and/or services is calculated at block 408 and included in the cost of the loan. Procedures included in evaluating such costs and in determining whether the bundling lender 212 will extend the loan are described in the '367 application, and may include obtaining an assessment of the real property by an appraiser, calculating a back-end ratio as a measure of the borrower's ability to repay the loan, and the like.

If the loan is approved, a deposit is made by the bundling lender 212 into the customer depository account 214 at block 412. The loan is repaid by the homeowner over time by making periodic payments to the bundling lender at block 416. Meanwhile,the funding of the customer depository account 214 permits the homeowner to make payments for the funded expenses.

Such an arrangement is combined in embodiments of the invention with securitization of the fiber and high-speed wireless networks by adding the total cost for providing the fiber and high-speed wireless networks and associated services for a given home to the first homeowner, referred to herein as the “network access charge.” This cost is included with the bundled services being included with the home when initially constructed or when telecommunications services are being purchased by an existing homeowner customer. When the telecommunications services are purchased, the network access change is added to the cost of the cost of the telecommunications services.

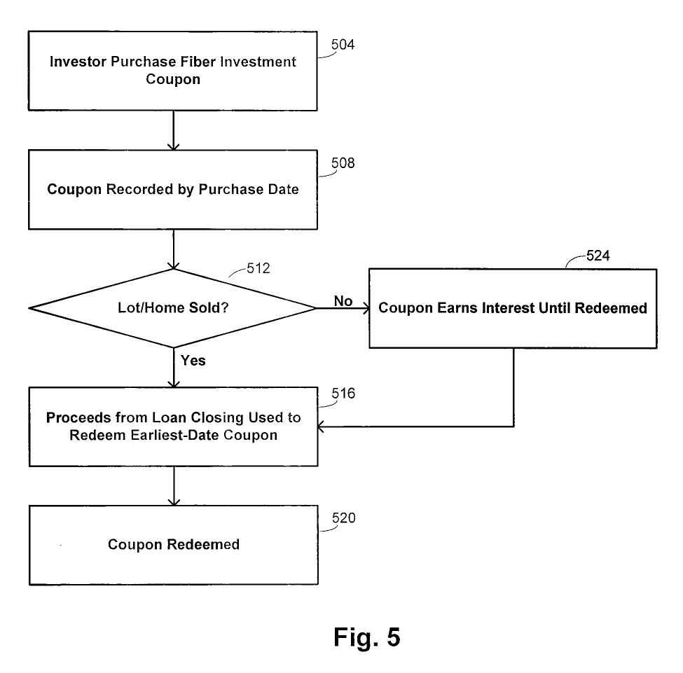

The securitization of the fiber network may be implemented as illustrated with the flow diagram of FIG. 5. At block 504, an investor purchases a fiber investment coupon that is tied to the price of the fiber unit cost, usually from the bundling company 202. In some instances, the coupon may be sold by a stock broker, financial advisor, or other entity in the business of selling investment and security instruments to accredited and non-accredited investors, with “accredited investors” referring herein to investors as defined in Rule 501(a) of Regulation D of the Securities and Exchange Commission, the entire disclosure of which is incorporated herein by reference for all purposes. The coupon has a face value that is greater than the cost of the coupon, being, for example, twice the cost of the coupon, three times the cost of the coupon, or five times the cost of the coupon in different embodiments. The coupon also has a maturity date that is related to the ratio of its face value to purchase cost. For example. Each coupon has an undivided interest in the fiber and high-speed wireless network connection to each lot or home in a selected subdivision. In some embodiments, the redemption of the coupon, i.e. payment of the face value plus interested earned to the investor by the bundling company 202, is based on a first-in-first-out formula. Thus, as indicated at block 508, coupons may be recorded as they are sold according to the date or purchase.

A check is made at block 512 whether a lot or home in the subdivision has been sold. If so, proceeds from the loan closing, particularly the payment of the network access charge, are used at block 516 to redeem the earliest-dated coupon(s). Each lot or home would thus have attached to it the network access charge and a fixed period of telecommunications charges. If not lots or homes are sold and a particular coupon has not been redeemed by the bundling company 202, the coupon begins to earn interest at block 524 until it is redeemed at block 520. Anytime after the maturity date, the bundling company 202 may redeem the coupon, with the coupon holder being paid the face value of the coupon plus any earned interest. In such embodiments, the investor has no demand or “put” rights for redemption of the coupon, which is limited to occurring as a result of a lot or home closing containing the network access charge, subject to the first-in-first-out formula, or by active redemption by the bundling company 202. Each coupon is secured by an undivided interest in the fiber cable and wireless network deployment in the subdivision and the revenue received by the bundling company 202 from the services delivered over the fiber and high-speed wireless connections to the homes in the subdivision. In embodiments where payment of the network access charge is not used by the bundling company 202 to redeem a coupon, other funding sources may be used, one example being USDA funding. In such an embodiment, the loan may be paid off using proceeds from homeowner loans when a homeowner finances his telecommunications services and the network access cost.

With such an arrangement, the bundling company 202 receives payment from the initial homeowner to cover the cost of: (1) the proportionate cost of the network operations center 104 and/or local distribution center(s) 108; (2) the proportionate cost of the common-area fiber and high-speed wireless deployment; and (3) the cost of the fiber drop to the home and the wireless equipment necessary to effect wireless connectivity to the fiber network. The arrangement advantageously mitigates the cost associated with laying optical-fiber lines and high-speed wireless equipment in and to a subdivision and the costs associated with building and equipping the network operations center 104 and/or local distribution center(s) 108. In addition, the bundling company advantageously acquires ownership to the fiber lines in a subdivision and increases balance-sheet assets. Advantages also inure to the homeowners by realizing an increase in property values. These various advantages may be understood by considering the following example, which is provided merely for purposes of illustration and is not intended to be limiting.

### EXAMPLE

Merely by way of illustration, it is estimated that currently the average cost to equip a network operations center 104 with the technology to deliver voice, video, home security, and network data is about $1.8 million, plus staffing costs. The cost of an unmanned local distribution center is estimated to be about $1,200,000 with no staffing costs. Laying 24-strand fiber to and throughout a subdivision, the common area, currently costs about $2 per running foot when the utility trench (for connecting sewer, water, and electrical in-ground service) is open. A typical subdivision may have an aggregated average of about 375 running feet per house, resulting in a common-area cost per house of about $750. The drop might average about 150 feet of fiber per house, resulting in a drop cost of about $300.

In addition to these costs, are costs of the network operations center 104 and the local distribution center(s) 108 amortized over the number of homes in the subdivision. For 2500 homes serviced by the network operations center 104 and the local distribution center(s) 108, this charge is about $720 per house. The total “fiber unit cost” per house in this example is thus about $1770. To make the fiber connection to each house operational, certain electronic equipment is additionally connected to the fiber line, with the approximate cost per house being $1150, including installation fees. The total cost to activate the network for each house is thus about $2920, determined by combining these electronics' costs with the fiber unit cost.

In this example, the fiber investment coupons are sold for $1770, an amount equal to the fiber unit cost, with each fiber investment coupon having a face value of $3540, i.e. twice its cost, and a maturity date twenty-four months from its date of issuance. The cost to finance the fiber network is thus $1770 using this program, resulting in a network access charge per home of $4690, computed as the sum of the fiber unit cost, the electronic equipment and installation cost, and securitization financing cost.

When a homeowner purchases bundled telecommunications services, the $4690 network access charge is included and results in a monthly cost of about $20 after accounting for its tax deductibility. Over five years, the homeowner's cost for the network access charge is thus about $1200. But the fiber connectivity has increased the value of the home. There are at least two methods by which this appreciation may be valued. First, the value of the fiber connection to the home may be considered to appreciate at the rate of the home's appreciation. For instance, if the home appreciated 11%/year, at the end of five years the network access charge valuation may rise from $4690 to $5485. Alternatively, the valuation may be made by determining the cost of providing the fiber connection. While the initial cost of the network access charge was based on the deployment of the fiber when the utility trench is open, once the trench is closed and improvements have been made by completing streets and curbing, the cost for laying the fiber is between about $10/foot and $20/foot depending on soil conditions. In the example where a house has a total of 375 running feet of common area and 150 feet of drop, for a total of 525 feet, trenching costs at $10/foot result in a fiber deployment value of $5250. Together with the $720 amortized value of the network operations center 104 and/or local distribution center(s) 108, the value of the fiber connection is about $5970. While the homeowner paid $1200 over five years for the network access charge, this resulted in an increase in home value between about $5500 and $6000.

When the homeowner decides to move, he can sell the network access charge to the bundling company 202. For instance, the bundling company may pay an amount for the network access charge equal to 10% of the annual telecommunications revenue for ten years purchased by the new homeowner when the new homeowner contracts for the bundled telecommunications services. If a new homeowner purchases $18,000 of telecommunications services over five years, the annual revenue recognition would be $3600 per year. Thus, the initial homeowner purchasing the lot or house, who pays $1200 out of pocket for the network access charge, may receive a $5970 increase in property value over five years and $3600 from the bundling company 202 on the purchase of the network access charge for a total of $9570. This represents a net gain of $8370 on the homeowner's $1200 cost.

The bundling company 202 would carry the value of the fiber on its balance sheet in the following way: (1) $2 cost per running foot when the fiber is initially deployed and the trench is open; (2) an increase in the cost per running foot to $10-20 after the trench is covered and improvements have been made; and (3) as much as $15,000 per subscriber when the fiber has been activated and the subscriber is receiving telecommunications services, a valuation based on current third-party valuations from the cable and telecommunications industries. The balance sheet for the bundling company 202 for a 2500-home subdivision would thus grow from a value of $4.4 million (2500 homes×$1770) to $8.625 million (2500 homes×$3540) when the trench is covered and improvements have been made to $37.5 million (2500 subscribers×$15,000) when homeowners are using the telecommunications services.

Relative to cashflow, in this example the bundling company 202 receives $1770 per lot or house for each fiber investment sold, with the land developer, homebuilder, or homeowner paying the bundling company for the network access charge calculated to be $3540. If the payment is made within the twenty-four months preceding the maturity date, the bundling company 202 receives interest on the $3540 to the date the funds are used to redeem the coupon, which may be performed by paying the investor the face value of $3540.

When a homeowner moves and the bundling company 202 purchases the network access charge, the purchase price would be $3600. Based on an updated valuation of the value of the telecommunications connection, as opposed to its value when it was deployed, the bundling company 202 would resell the network access charge for up to about $5970, representing a gain of about $2370 with the bundling company 202 retaining ownership of the fiber.

This securitization arrangement thus provides a number of benefits both for the bundling company and for the homeowners purchasing telecommunications services.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of securitizing a network to a group of homes, the method comprising:
receiving, at a host system, an identification of real property for one of the homes;
calculating, with the host system, a total loan value for the real property that includes a network access charge representing a unit cost for establishing a network connection from the real property to a network operations center to access telecommunications services and includes an activation cost for activating the network connection; and
initiating, with the host system, a loan secured by the real property for the total loan value.

2. The method recited in claim 1 further comprising initiating issuance of an investment coupon to an investor to generate funds to finance costs for establishing the network connection.

3. The method recited in claim 2 wherein the investment coupon includes an undivided interest in the network.

4. The method recited in claim 2 wherein the investment coupon is issued according to a first-in-first-out formula.

5. The method recited in claim 2 wherein the investment coupon is issued for a cost approximately equal to the unit cost.

6. The method recited in claim 2 further comprising initiating redemption of the investment coupon.

7. The method recited in claim 6 wherein redemption of the investment coupon is initiated in response to closing the loan.

8. The method recited in claim 1 wherein the unit cost comprises a cost for establishing a network connection from the real property to a local distribution center and a cost for establishing a network connection from the local distribution center to the network operations center.

9. The method recited in claim 1 wherein the telecommunications services comprise at least one of voice, video, data, and home-security services.

10. The method recited in claim 1 wherein the network comprises a fiber network and the network connection comprises a fiber network connection.

11. The method recited in claim 1 wherein the network comprises a high-speed wireless network and the network connection comprises a high-speed wireless connection.

12. A method of securitizing a network to a group of homes, the method comprising:
initiating, with a host system, issuance of a plurality of investment coupons to investors to generate funds to finance costs for establishing the network,
wherein each of the investment coupons includes an undivided interest in the network.

13. The method recited in claim 12 wherein the investment coupons are issued according to a first-in-first-out formula.

14. The method recited in claim 12 further comprising initiating redemption of at least one of the investment coupons.

15. The method recited in claim 14 wherein redemption of the at least one of the investment coupons is initiated in response to closing a loan for purchase of one of the homes.

16. The method recited in claim 12 wherein the network comprises a fiber network and the network connection comprises a fiber network connection.

17. The method recited in claim 12 wherein the network comprises a high-speed wireless network and the network connection comprises a high-speed wireless network connection.
